(19) United States
(12) Patent Application Publication
(10) Pub. No.: US 2007/0121231 A1
(43) Pub. Date: May 31, 2007

(54) COLOR WHEEL CAPABLE OF REDUCING COLOR COORDINATE DEVIATIONS AFTER COLOR MIXING

(76) Inventor: Chao-Han Pao, Miao- Li Hsien (TW)

Correspondence Address: NORTH AMERICA INTELLECTUAL PROPERTY CORPORATION, P.O. BOX 506, MERRIFIELD, VA, 22116, US

(21) Appl. No.: 11/563,022

(22) Filed: Nov. 23, 2006

(30) Foreign Application Priority Data
Nov. 25, 2005 (TW) 094141455

(51) Int. Cl. H04N 9/12; G02B 7/00

(52) U.S. Cl. 359/892; 348/743

(57) ABSTRACT

A color wheel of a projector includes a red segment, a green segment, a blue segment and a white segment. The white segment is coated so as to provide color temperature of 6500K or 7000K. The red, green and blue segments are coated so as to provide full-segment transmission. The area ratio of the red segment, the green segment and the blue segment on the color wheel is designed based on the color temperature of the color wheel, so that color coordinate deviations can be reduced.

### BACKGROUND OF THE INVENTION

1. Field of the Invention

The present invention relates to a color wheel, and more particularly, to a color wheel capable of reducing color coordinate deviations after color mixing.

2. Description of the Prior Art

With rapid development of technology, projectors have been widely used in conference briefings or household applications. In recent years, with growing demand for large-sized flat panel displays, larger display sizes and higher display quality are required and related projecting technologies are being developed. With projecting technologies, images can be projected onto a screen and the sizes of the images can be enlarged optically, so as to break through the size limitations of flat display panels and to achieve thinner and lighter display devices. Common projecting technologies include cathode ray tube (CRT), liquid crystal display (LCD), digital light processing (DLP), and liquid crystal on silicon (LCOS) technologies. Among these technologies, DLP projectors, developed by Texas Instruments (TI), are projecting displays that operate based on special modulated light sources. DLP projectors are full-digital reflective projectors characterized in smaller sizes, lighter weight and the ability to subtilize projected images.

FIG. 1 shows a diagram of a DLP projector. The DLP projector in FIG. 1 includes a light source 5, a color wheel 20, a digital micro-mirror display (DMD) chip 15, a first condensing lens 11, a second condensing lens 12, and a projecting lens 13. Light emitted by the light source 5 is condensed by the first condensing lens 11, passes through the color wheel 20, is condensed by the second condensing lens 12, and then is projected onto the DMD chip 15. Each pixel of the DMD chip 15 includes memory that records digital signals of a corresponding pixel and the digital signals are sent by driving circuits. Therefore, the deflecting angles of the micro-mirrors and the deflecting time can be controlled for projecting light onto a screen 16 via the projecting lens 13.

The color wheel 20 usually has a 4-segment or a 5-segment structure including red, green, blue and white segments and achieves full color display by 4-color color mixing. FIG. 2 shows a diagram of the color wheel 20. The color wheel 20 has a 4-segment structure which includes a red segment 22, a green segment 24, a blue segment 26, and a white segment 28. The area ratios of these segments determine the color performance of the DLP projector. For example, a larger area of the white segment 28 results in stronger light intensity provided by the DLP projector. In the prior art, the white segment 28 of the color wheel 20 is coated so as to provide full-segment transmission.

FIG. 3 shows a spectrum distribution of the white segment 28 of the color wheel 20. Since the white segment 28 of the color wheel 20 is coated so as to provide full-segment transmission, the spectrum range of the white segment 28 is between 380 nm to 780 nm wavelengths, so that maximum transmission rate can be achieved. As shown in FIG. 3, the white segment 28 having full-segment transmission provides nearly 100% transmission rate between 380 nm to 780 nm wavelengths.

Human eyes perceive colors in a complicated way. In order to quantify color descriptions, the International Commission on Illumination (CIE) provides a color matching function (known as the CIE 1931 color matching function) of the three prime colors red, green and blue based on visual experiments in which how human eyes react to radiation of different wavelengths is recorded and analyzed. Based on this color matching function, color descriptions can be quantified and represented by color coordinates. In the prior art, the white segment 28 of the color wheel 20 is coated so as to provide full-segment transmission. Due to characteristics of light spectrum distribution, the color coordinate of the white segment 28 differs a lot from that of a mixed white color obtained by the red segment 22, the green segment 24, and the blue segment 26, causing huge color coordinate deviation during gray scale color mixing. For example, in the prior art color wheel 20, a first color coordinate of the white segment 28 is around (0.299, 0.309, 0.392), a second color coordinate of a mixed white color obtained by the red segment 22, the green segment 24, and the blue segment 26 is around (0.315, 0.336, 0.349), and a third color coordinate obtained by gray scale color mixing using the red segment 22, the green segment 24, the blue segment 26 and the white segment 28 is around (0.302, 0.320, 0.378). Therefore, the color coordinate deviation during gray scale color mixing, which is the difference between the third and the second color coordinates, is around (−0.013, −0.016, 0.029).

In the prior art projector, the white segment of the color wheel is coated so as to provide full-segment transmission. Therefore, the color coordinate obtained by gray scale color mixing using the red, green, blue and white segments differs a lot from that of the mixed white color obtained by the red, green, and the blue segments, thus resulting in large color coordinate deviation during gray scale color mixing.

### SUMMARY OF THE INVENTION

The present invention provides a color wheel capable of reducing color coordinate deviations after color mixing, comprising: a white segment having a color temperature around 6500K; a red segment providing full-segment transmission; a green segment providing full-segment transmission; and a blue segment providing full-segment transmission; wherein an area ratio of the white to the red segments is around 0.46, an area ratio of the green to the red segments is between 0.51 and 0.71, and an area ratio of the blue to the red segments is between 0.4 and 0.6.

The present invention also provides a color wheel capable of reducing color coordinate deviations after color mixing, comprising: a white segment having a color temperature around 7000K; a red segment providing full-segment transmission; a green segment providing full-segment transmission; and a blue segment providing full-segment transmission; wherein an area ratio of the white to the red segments is around 0.47, an area ratio of the green to the red segments is between 0.48 and 0.68, and an area ratio of the blue to the red segments is between 0.42 and 0.62.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a diagram of a DLP projector.

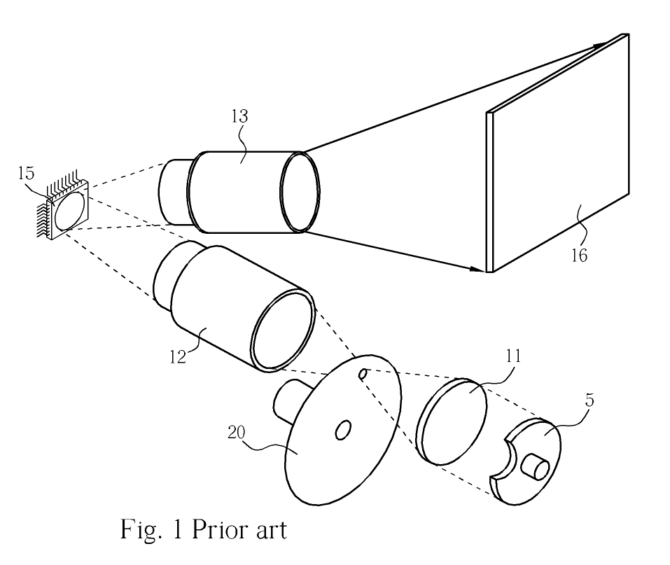

FIG. 2 shows a diagram of a prior art color wheel.

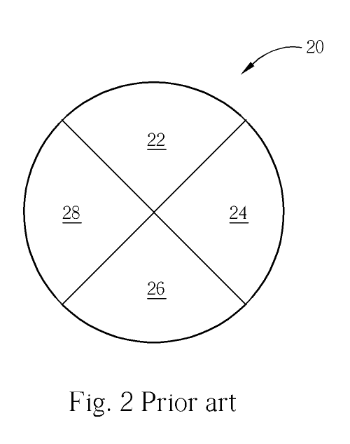

FIG. 3 shows a spectrum distribution of a white segment of the color wheel in FIG. 2.

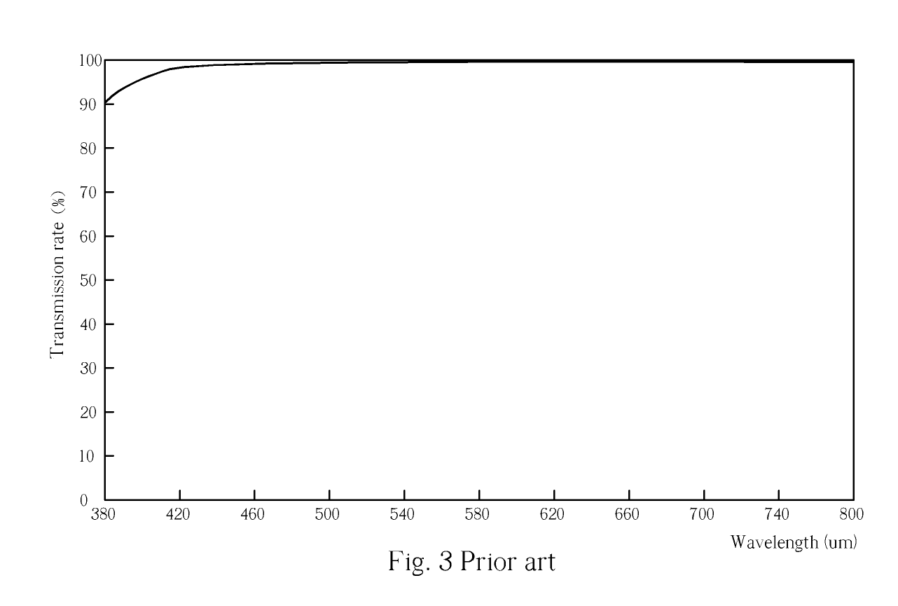

FIG. 4 shows a color wheel according to a first embodiment of the present invention.

FIG. 5 shows a spectrum distribution of a white segment of the color wheel according to the first embodiment of the present invention.

FIG. 6 shows a color wheel according to a second embodiment of the present invention.

FIG. 7 shows a spectrum distribution of a white segment of the color wheel according to the second embodiment of the present invention.

### DETAILED DESCRIPTION

The CIE 1931 chromaticity system will be explained in more detail. A projector uses a color additive process based on three prime colors: red, green and blue. The wavelengths λ_{R},λ_{G},λ_{B} of the red, green and blue colors are specified by the CIE in 1931 as follows:
λ_{R}=700 nm;
λ_{G}=546.1 nm;
λ_{B}=43 5.8 nm;

Based on the above specifications, all natural colors can be obtained by mixing the three prime colors with a certain proportion, and tristimulus values X, Y, Z can be used to respectively represent the composition of the three prime colors constituting a certain color. The color coordinate (x, y, z) of a color can therefore be defined as follows:
x=X/(X+Y+Z);
y=Y/(X+Y+Z);
z=Z/(X+Y+Z);
where x+y+z=1

Since the sum of x, y, and z equals 1, a color can be uniquely defined as long as x and y are provided. Therefore, all colors in the light spectrum can be represented in a two-dimensional plane. For different applications, the CIE also defines various light-emitting bodies using a standard black body. A light-emitting body can be described using a color temperature, whose standard unit is Kelvin (K). The Kelvin unit is the basis of all temperature measurements, starting with 0 K, which equals to −273.16° C.(Celsius), at the absolute zero temperature. Technically, color temperature refers to the temperature to which one would have to heat the standard black body to emit light of the same visual color. For example, the light emitted by a light-emitting body D65 having 6500K color temperature is equivalent to that emitted by the standard black body when heated to around 6227° C., and the light emitted by a light-emitting body D70 having 7000K color temperature is equivalent to that emitted by the standard black body when heated to around 6727° C. According to the CIE specifications, the color coordinate of D65 is around (0.3127, 0.329, 0.3582), and the color coordinate of D70 is around (0.3064, 0.3166, 0.377).

High-resolution displays usually adopt a default RGB color space, also known as standard RGB (sRGB) space, and define color coordinates of the red, green and blue colors according to the ITU-R BT.709 standard as follows:
R(x, y, z)=(0.61, 0.33, 0.03);
G(x, y, z)=(0.3, 0.6, 0.1);
B(x, y, z)=(0.15, 0.06, 0.79);

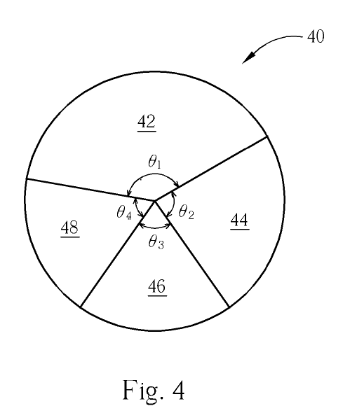

FIG. 4 shows a color wheel 40 according to a first embodiment of the present invention. The color wheel 40, with a 4-segment structure, includes a red segment 42, a green segment 44, a blue segment 46, and a white segment 48. A1-A4 represent the areas on the color wheel 40 occupied by the red segment 42, the green segment 44, the blue segment 46, and the white segment 48, respectively. In the first embodiment, the red segment 42, the green segment 44, the blue segment 46, and the white segment 48 continuously occupy pie-shaped areas on the color wheel 40. The borderlines extending from the center of the color wheel 40 define the area each color segment occupies, so that the angles formed by two borderlines of the red, green, blue, and white segments with respect to the center of the color wheel 40 are represented by θ1-θ4, respectively. In the first embodiment, θ1 is 140 degrees, θ2 is 85 degrees, θ3 is 70 degrees, and θ4 is 65 degrees. In other words, using the area A1 of the red segment 42 as a base, the areas A2-A4 of the green segment 44, the blue segment 46, and the white segment 48 have the following relationship:
A2/A1≈0.607;
A3/A1=0.5;
A4/A1≈0.464;

In contrast to the prior art color wheel 20 providing full-segment transmission, the red segment 42, the green segment 44, and the blue segment 46 are coated according to the ITU-R BT.709 standard, and the white segment 48 is coated so as to provide 6500K color temperature. In other words, the target color coordinates of each segment of the color wheel 40 are listed as follows:
R_{target}(x, y, z)≈(0.61, 0.33, 0.03);
G_{target}(x, y, z)≈(0.3, 0.6, 0.1);
B_{target}(x, y, z)≈(0.15, 0.06, 0.79);
W_{target}(x, y, z)≈(0.3127, 0.329, 0.3583);

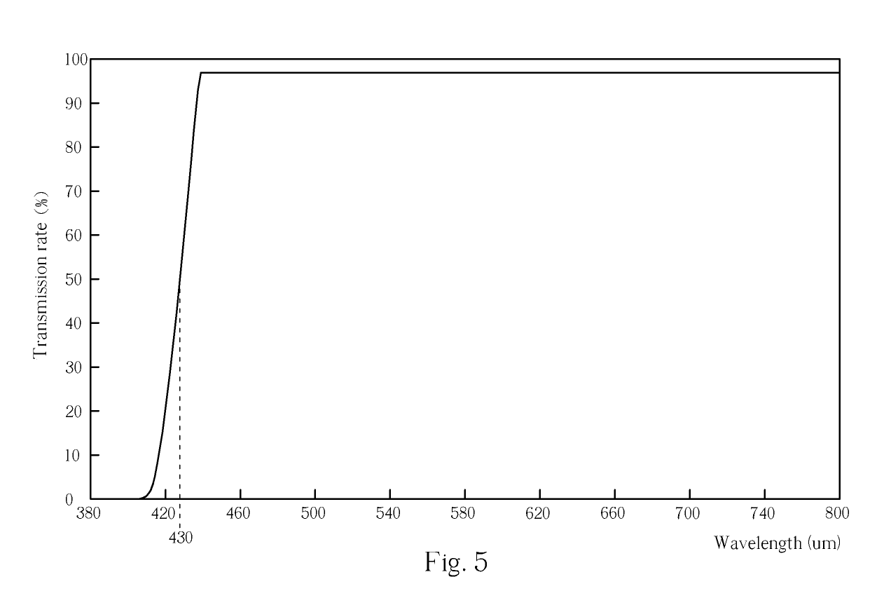

FIG. 5 shows a spectrum distribution of the white segment 48 in the color wheel 40 according to the first embodiment of the present invention. In order to provide 6500K color temperature, the white segment 48 of the color wheel 40 is coated so as to provide 50% transmission rate at 430±4 nm wavelength. Based on the spectrum distribution of the white segment 48 shown in FIG. 5, the color coordinate of the white segment 48 can be represented by the following formulae:
(x′, y′, z′)=(x, y, z)*T(λ); formula 1:
Wx=Σx′/(Σx′+Σy′+Σz′); formula 2:
Wy=Σy′/(Σx′+Σy′+Σz′); formula 3:
Wz=Σz′/(Σx′+Σy′+Σz′); formula 4:

wherein (x, y, z) is the color coordinate of the light having a certain wavelength before passing through the white segment 48;

(x′, y′, z′) is the color coordinate of the light having a certain wavelength after passing through the white segment 48;

(Wx, Wy, Wz) is the color coordinate representing the light of all wavelengths after passing through the white segment 48; and

T(λ) is the transmission rate of the white segment 48 at a wavelength equals to λ;

Therefore, a fourth color coordinate of the white segment 48 is around (0.309, 0.331, 0.36), a fifth color coordinate of a mixed white color obtained by the red, green, and blue segments is around (0.316, 0.329, 0.355), and a sixth color coordinate obtained by gray scale color mixing using the red, green, blue, and white segments is around (0.306, 0.326, 0.368). As a result, in the color wheel 40 of the present invention, the color coordinate deviation during gray scale color mixing, which is the difference between the sixth and the fifth color coordinates, is around (−0.01, −0.003, 0.013), which is much smaller than the color coordinate deviation (−0.013, −0.016, 0.029) obtained in the prior art color wheel 20.

In the first embodiment shown in FIG. 4, the red segment 42, the green segment 44, the blue segment 46, and the white segment 48 continuously occupy pie-shaped areas on the color wheel 40 and the angles θ1-θ4 formed by two borderlines of each segment with respect to the center of the color wheel 40 equal to 140, 85, 70 and 65 degrees, respectively. However, the present invention is not limited to color wheels having the area ratios and the continuous pie-shaped segments shown in FIG. 4. In the color wheel 40 with the coated white segment 48 for providing 6500K color temperature, the area ratio A2/A1 can be between 0.51 and 0.71, and the area ratio A3/A1 can be between 0.4 and 0.6.

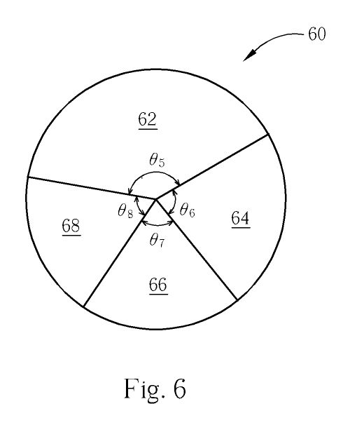

FIG. 6 shows a color wheel 60 according to a second embodiment of the present invention. The color wheel 60, with a 4-segment structure, includes a red segment 62, a green segment 64, a blue segment 66, and a white segment 68. B1-B4 represent the areas on the color wheel 60 occupied by the red segment 62, the green segment 64, the blue segment 66, and the white segment 68, respectively. In the second embodiment, the red segment 62, the green segment 64, the blue segment 66, and the white segment 68 continuously occupy pie-shaped areas on the color wheel 60. The borderlines extending from the center of the color wheel 60 define the borders between each segment, so that the angles formed by two borderlines of the red, green, blue, and white segments with respect to the center of the color wheel 60 are represented by θ5-θ8, respectively. In the second embodiment, θ5 is 140 degrees, θ6 is 81 degrees, θ7 is 73 degrees, and θ8 is 66 degrees. In other words, using the area B1 of the red segment 62 as a base, the areas B2-B4 of the green segment 64, the blue segment 66, and the white segment 68 have the following relationship:
B2/B1≈0.579;
B3/B1≈0.521;
B4/B1≈0.471;

In contrast to the prior art color wheel 20 providing full-segment transmission, the red segment 62, the green segment 64, and the blue segment 66 are coated according to the ITU-R BT.709 standard, and the white segment 68 is coated so as to provide 7000K color temperature. In other words, the target color coordinates of each segment of the color wheel 60 are listed as follows:
R_{target}(x, y, z)≈(0.61, 0.33, 0.03);
G_{target}(x, y, z)≈(0.3, 0.6, 0.1);
B_{target}(x, y, z)≈(0.15, 0.06, 0.79);
W_{target}(x, y, z)≈(0.3127, 0.329, 0.3583);

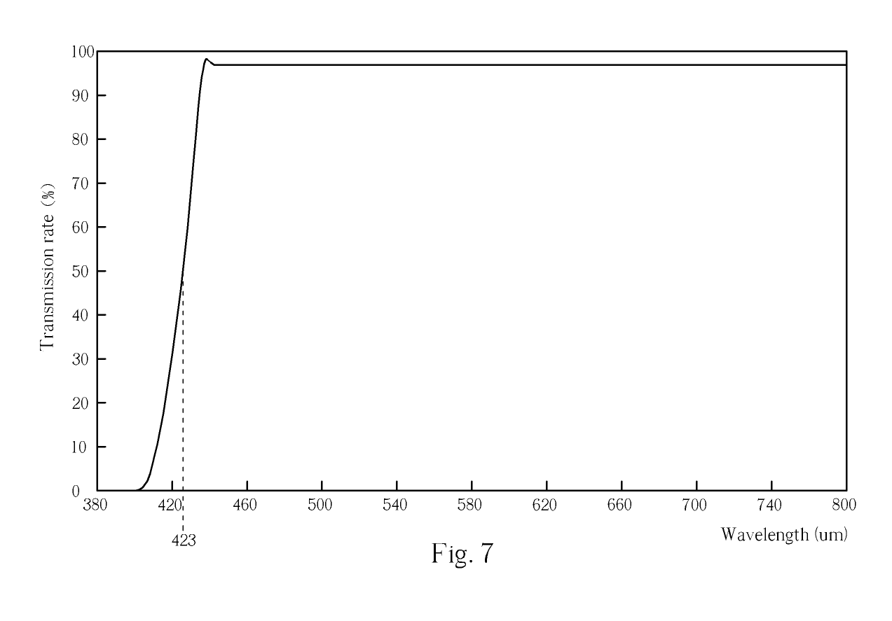

FIG. 7 shows a spectrum distribution of the white segment 68 in the color wheel 60 according to the second embodiment of the present invention. In order to provide 7000K color temperature, the white segment 68 of the color wheel 60 is coated so as to provide 50% transmission rate at 423±4 nm wavelength. Based on the spectrum distribution of the white segment 68 shown in FIG. 7 and formulae 1-4, a seventh color coordinate of the white segment 68 is around (0.302, 0.317, 0.381), an eighth color coordinate of a mixed white color obtained by the red, green, and blue segments is around (0.312, 0.316, 0.372), and a ninth color coordinate obtained by gray scale color mixing using the red, green, blue, and white segments is around (0.302, 0.314, 0.384). As a result, in the color wheel 60 of the present invention, the color coordinate deviation during gray scale color mixing, which is the difference between the ninth and the eighth color coordinates, is around (−0.01, −0.002, 0.012), is much smaller than the color coordinate deviation (−0.013, −0.016, 0.029) obtained in the prior art color wheel 20.

In the second embodiment shown in FIG. 6, the red segment 62, the green segment 64, the blue segment 66, and the white segment 68 continuously occupy pie-shaped areas on the color wheel 60 and the angles θ5-θ8 formed by two borderlines of each segment with respect to the center of the color wheel 40 equal to 140, 81, 73 and 66 degrees, respectively. However, the present invention is not limited to color wheels having the area ratios and the continuous pie-shaped segments shown in FIG. 6. In the color wheel 60 with the white segment 68 coated for providing 7000K color temperature, the area ratio B2/B1 can be between 0.479 and 0.679, and the area ratio B3/B1 can be between 0.421 and 0.621.

In the prior art, the white segment of the color wheel is coated for providing full-segment transmission. Therefore, the color coordinate obtained after gray scale color mixing using the red, green, blue and white segments differs a lot from that of the mixed white color obtained by the red, green, and the blue segments, resulting in large color coordinate deviation. In the present invention, the white segment of the color wheel is coated for providing 6500K or 7000K color temperature, and the area ratio of the red, green and blue segments on the wheel is adjusted based on the color temperature of the white segment. Therefore, the difference between the color coordinate obtained after gray scale color mixing using red, green, blue and white segments and that of the mixed white color obtained by the red, green, and the blue segments can be reduced. The present invention is capable of lowering color coordinate deviation during gray scale color mixing.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A color wheel capable of reducing color coordinate deviations after color mixing, comprising:
a white segment having a color temperature around 6500K;
a red segment providing full-segment transmission;
a green segment providing full-segment transmission; and
a blue segment providing full-segment transmission;
wherein an area ratio of the white to the red segments is around 0.46, an area ratio of the green to the red segments is between 0.51 and 0.71, and an area ratio of the blue to the red segments is between 0.4 and 0.6.

2. The color wheel of claim 1 wherein a color coordinate (x, y, z) of the red segment in a standard RGB color space according to the ITU-R BT.709 standard is around (0.61, 0.33, 0.03).

3. The color wheel of claim 1 wherein a color coordinate (x, y, z) of the green segment in a standard RGB color space according to the ITU-R BT.709 standard is around (0.3, 0.6, 0.1).

4. The color wheel of claim 1 wherein a color coordinate (x, y, z) of the blue segment in a standard RGB color space according to the ITU-R BT.709 standard is around (0.15, 0.06, 0.79).

5. The color wheel of claim 1 being a color wheel of a projector.

6. The color wheel of claim 1 wherein an area ratio of the green to the red segments is around 0.61.

7. The color wheel of claim 1 wherein an area ratio of the blue to the red segments is around 0.5.

8. A color wheel capable of reducing color coordinate deviations after color mixing, comprising:
a white segment having a color temperature around 7000K;
a red segment providing full-segment transmission;
a green segment providing full-segment transmission; and
a blue segment providing full-segment transmission;
wherein an area ratio of the white to the red segments is around 0.47, an area ratio of the green to the red segments is between 0.48 and 0.68, and an area ratio of the blue to the red segments is between 0.42 and 0.62.

9. The color wheel of claim 8 wherein a color coordinate (x, y, z) of the red segment in a standard RGB color space according to the ITU-R BT.709 standard is around (0.61, 0.33, 0.03).

10. The color wheel of claim 8 wherein a color coordinate (x, y, z) of the green segment in a standard RGB color space according to the ITU-R BT.709 standard is around (0.3, 0.6, 0.1).

11. The color wheel of claim 8 wherein a color coordinate (x, y, z) of the blue segment in a standard RGB color space according to the ITU-R BT.709 standard is around (0.15, 0.06, 0.79).

12. The color wheel of claim 8 being a color wheel of a projector.

13. The color wheel of claim 8 wherein an area ratio of the green to the red segments is around 0.58.

14. The color wheel of claim 1 wherein an area ratio of the blue to the red segments is around 0.52.
